(19) United States
(12) Patent Application Publication
(10) Pub. No.: US 2026/0116315 A1
(43) Pub. Date: Apr. 30, 2026

(54) ATTACHMENT METHODS FOR DIRECT TRAILER POSE MEASUREMENT SYSTEMS

(71) Applicant: Torc Robotics, Inc., Blacksburg, VA (US)

(72) Inventors: Garrett Madsen, Austin, TX (US); William Gray Davis, Austin, TX (US); Joseph R. Fox-Rabinovitz, Austin, TX (US)

(21) Appl. No.: 18/929,266

(22) Filed: Oct. 28, 2024

(51) Int. Cl. B60R 11/02; B60R 11/00; B60R 11/04

(52) U.S. Cl. CPC B60R 11/0258; B60R 11/04; B60R 2011/004; B60R 2011/005

(57) ABSTRACT

A sensor attachment system for an autonomous vehicle includes an arm assembly attached to a tractor portion of the autonomous vehicle, the arm assembly moveable between a retracted position and a deployed position. The arm assembly includes a first joint attached to the tractor portion at a first location; a beam arm coupled with the first joint, the beam arm being moveable relative to the first joint; and a sensor coupler provided along a length of the beam arm, the sensor coupler being adapted to affix one or more sensors at a second location on the trailer portion of the autonomous vehicle.

### TECHNICAL FIELD

The field of the disclosure relates to autonomous vehicles and, in particular, to sensor placement assemblies for autonomous trucks.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Some autonomous vehicles include multiple bodies, such as autonomous trucks with a tractor portion and a trailer portion. The trailer portion may be coupled or linked to the tractor portion. When the autonomous truck is operational (e.g., driving or moving along a roadway), the trailer portion may be subject to external forces, such as wind shear, vibrations, or the like. In response to shifting or movement, the tractor portion may enact corrective or preventative behaviors to maintain stability of the entire vehicle. Accordingly, one or more sensors may be required on or at the trailer portion to monitor movements or shifts in the trailer. Once the trailer is delivered to the required location, the trailer is typically uncoupled from the tractor. During its useful life, the tractor will likely be coupled and uncoupled from a large number of trailers. A tractor would be able to sense the undesirable trailer movement/shifting if the trailer it is coupled to includes the additional required sensors. If the trailer is not equipped with the required sensors the tractor will not be able to sense the undesirable trailer movement. Equipping and retrofitting trailers with the movement sensors would be expensive, time consuming proposition.

Accordingly, there exists a need for a system and a method to automatically or autonomously attach one or more sensors to an autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect of the present disclosure, a sensor attachment system for an autonomous vehicle is provided. The sensor attachment system may include an arm assembly attached to the autonomous vehicle, the arm assembly being moveable between a retracted position and a deployed position. The arm assembly may include a first hinge attached to the autonomous vehicle at a first location and a beam arm coupled with the first hinge. The beam arm may be moveable relative to the first hinge. The arm assembly may further include a sensor coupler provided along a length of the beam arm, the sensor coupler being adapted to affix one or more sensors at a second location on the autonomous vehicle.

In another aspect of the present disclosure, a method of operating an autonomous vehicle is provided. The autonomous vehicle may include an arm assembly. The method may include determining that the autonomous vehicle is activated, directing the arm assembly to move from a retracted position to a deployed position in response to determining that the autonomous vehicle is activated, and attaching one or more sensors to the trailer via a sensor coupler when the arm assembly is in the deployed position.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of an autonomous vehicle according to an exemplary embodiment of the present disclosure;

FIG. 2 is a perspective view of the exemplary autonomous vehicle of FIG. 1 with a trailer coupled thereto;

FIG. 3 is a side view of the exemplary autonomous vehicle and trailer of FIG. 2;

FIG. 4 is a block diagram of the exemplary autonomous vehicle of FIG. 1;

FIG. 5 is a schematic view of the autonomous vehicle of FIG. 1 showing an exemplary arm assembly attached thereto in a retracted position;

FIG. 6 is a schematic view of the autonomous vehicle of FIG. 1 showing an exemplary arm assembly attached thereto in a deployed position; and

FIG. 7 is a flow chart illustrating a method of operating an autonomous vehicle according to exemplary embodiments of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, an adjustable arm assembly for positioning and placing one or more instruments (e.g., sensors, cameras, etc.) on an attached trailer coupled to the autonomous vehicle. The adjustable arm assembly may be movable between a retracted position and a deployed position. The adjustable arm assembly may include a hinge coupled to the autonomous vehicle, a beam arm movable with respect to the hinge, and a sensor coupler positioned along the length of the beam arm. The sensor coupler may selectively couple or decouple the one or more sensors to the attached trailer. The adjustable arm assembly may be autonomously controlled. For instance, the adjustable arm assembly may be configured or adapted to automatically move from the retracted position to the deployed position upon a start-up or activation of the autonomous vehicle.

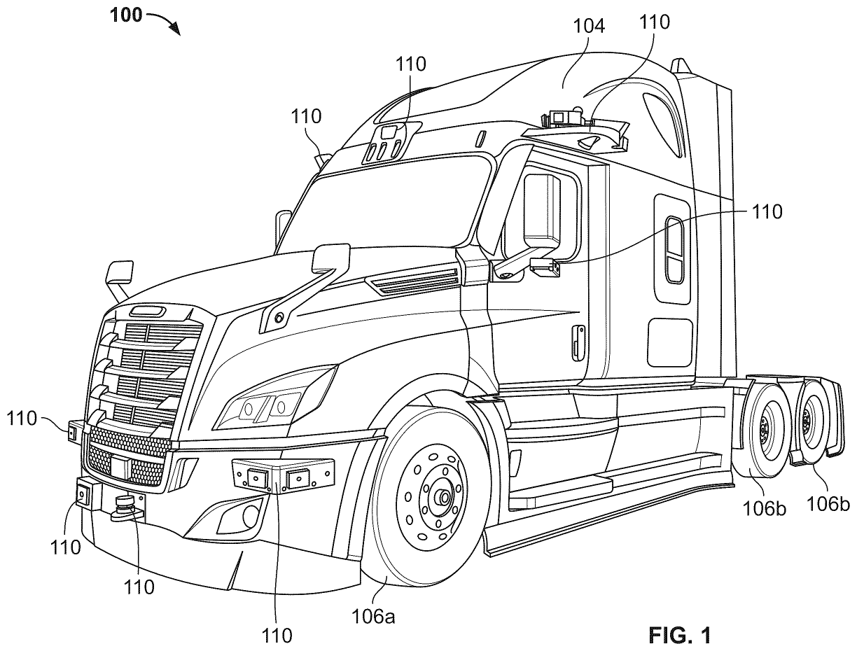

Various embodiments in the present disclosure are described with reference to FIGS. 1-3 below.

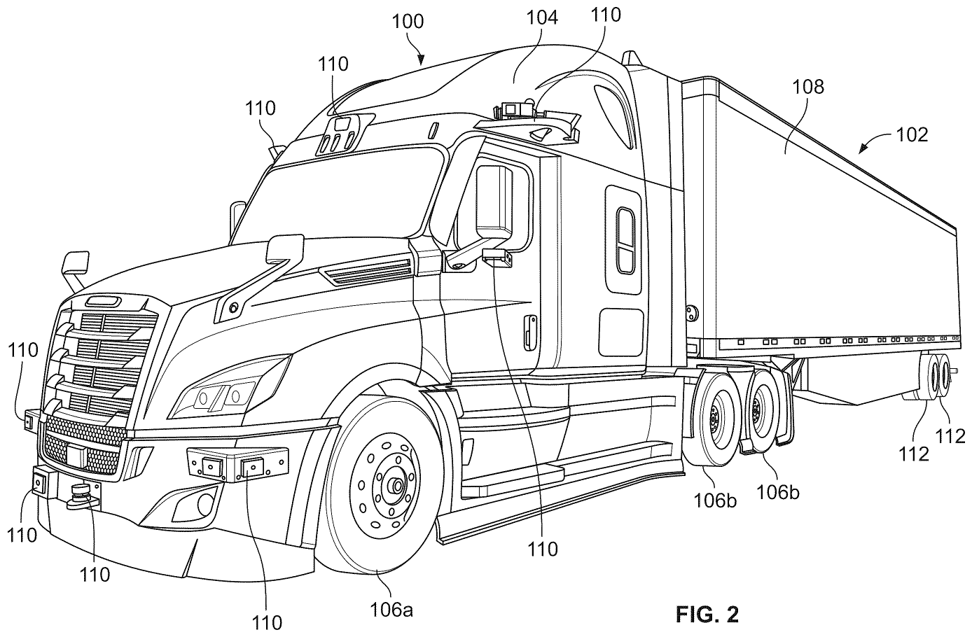

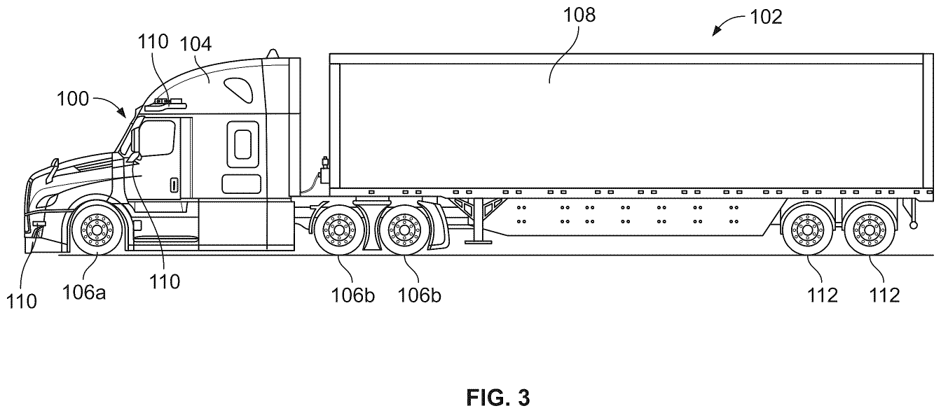

FIG. 1 is a perspective view of a vehicle 100, such as a truck that may be conventionally connected to a single or tandem trailer 102 to transport trailer 102 to a desired location, as shown in FIGS. 2 and 3, which are, respectively, perspective and side views of vehicle 100 of FIG. 1 with trailer 102 attached thereto. Vehicle 100 includes a cabin 104 that can be supported, and steered in the required direction, by front wheels 106a and rear wheels 106b that are partially shown in FIG. 1. Front wheels 106a are positioned by a steering system that includes a steering wheel and a steering column (not shown). The steering wheel and the steering column may be located in the interior of cabin 104.

Vehicle 100 may be an autonomous vehicle, in which case vehicle 100 may omit the steering wheel and the steering column to steer vehicle 100. Rather, vehicle 100 may be operated by an autonomy computing system of vehicle 100 based on data collected by a sensor network including one or more sensors, e.g., sensors 110 shown in FIGS. 1-3. Vehicle 100 may additionally include a fifth-wheel coupling (not shown) to which trailer 102 can be releaseably attached. Trailer 102 can include a storage container 108 and a plurality of rear wheels 112 that support storage container 108. It should be understood that in some embodiments vehicle 100 and trailer 102 can be a permanently attached as a single unit.

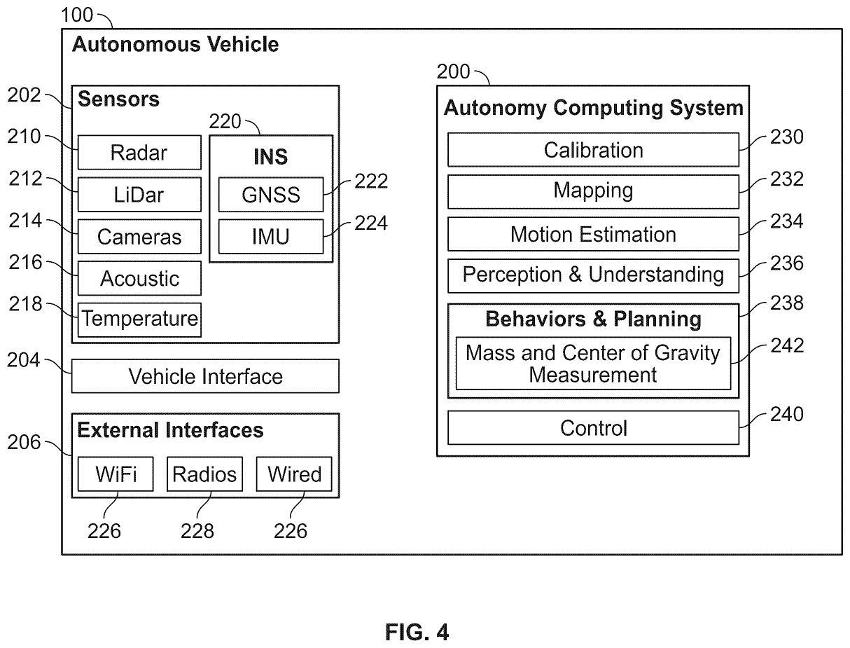

FIG. 4 is a block diagram of vehicle (e.g., autonomous vehicle) 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100. Additionally or alternatively, as will be explained further below, one or more sensors 202 may be selectively attached to and/or detached from autonomous vehicle 100 (e.g., to an attached trailer).

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

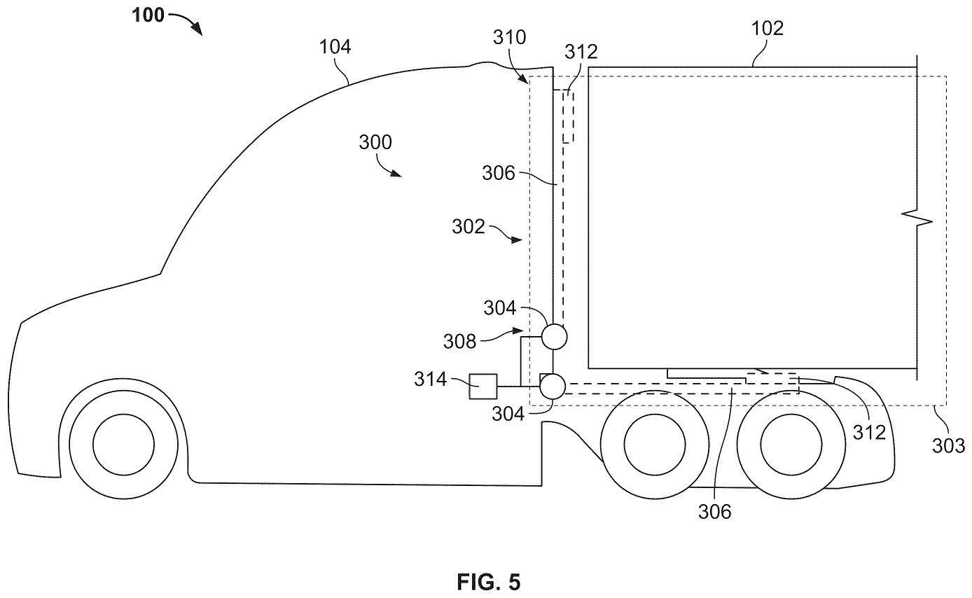

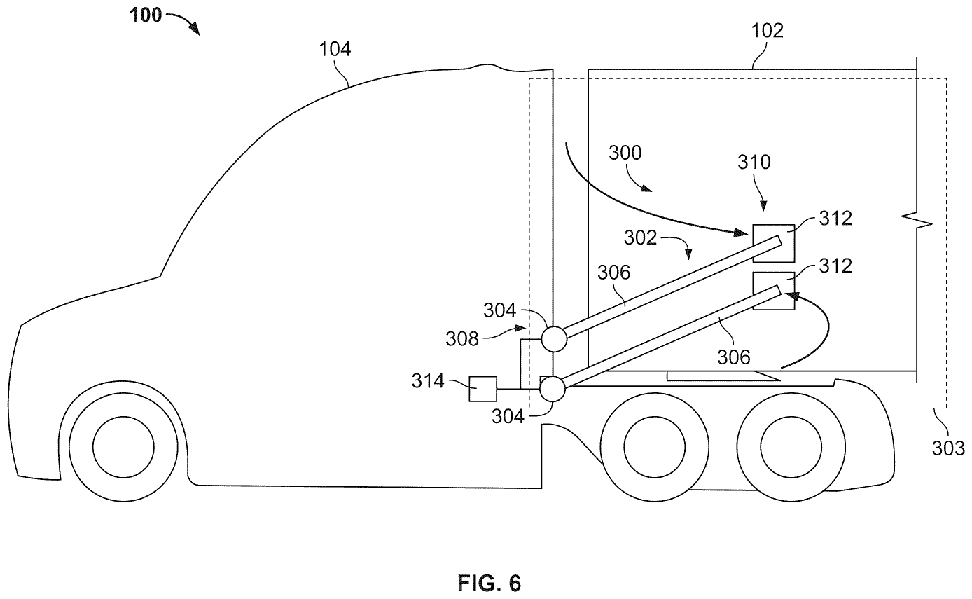

Referring now to FIGS. 5 and 6, a sensor attachment system 300 for autonomous vehicle 100 will be described in detail. Sensor attachment system 300 may include one or more parts or assemblies configured to selectively position and attach a sensor, camera, IMU, or other equipment along either vehicle 100 or an attached body (e.g., such as trailer 102). Sensor attachment system 300 may include an arm assembly 302. Arm assembly 302 may be attached to autonomous vehicle 100. For instance, arm assembly 302 may be coupled to vehicle 100 (e.g., cab 104) via a first hinge 304. First hinge 304 may be a multi-directional or omni-directional hinge or joint. For instance, first hinge 304 may include a bracket, a socket, or other joint allowing for movement of an arm (described below). Hereinafter, a “hinge” refers to an element or connection that allows an arm (e.g., a beam arm, described below) to be moved in the manner required to position a sensor (e.g., sensor 202) at a desired location along the trailer, such as the side 108 of vehicle 100. According to at least some examples, first hinge 304 may be capable of maneuvering a portion of arm assembly (e.g., the beam arm) in at least 6 degrees of freedom. In detail, first hinge 304 may allow the beam arm to rotate, pivot, extend, shift, sway, or otherwise move in multiple directions. Thus, arm assembly 302 may be moveable between a retracted position (e.g., FIG. 5) and a deployed position (e.g., FIG. 6).

According to at least one embodiment, arm assembly 302 may be configured to rotate within a defined plane 303 such as a plane that is parallel to the plane defined by the longitudinal wall 108 of the trailer. A tractor or cab 104 may have a width along the lateral direction that is greater than a width of an attached trailer 102. In such instances, first hinge 304 may include one or more devices to pivot arm assembly 302 within the defined plane 303 (e.g., between the retracted position and the deployed position). The one or more devices may include a gear system, a ratchet system, a pulley system, or the like.

First hinge 304 may be or include multiple pieces, such as a multi-bar linkage. First hinge 304 may be configured to articulate, shift, or otherwise move outward (e.g., along a lateral direction). As mentioned above, vehicle 100 may include a tractor portion (e.g., cab 104) and an attached trailer (e.g., trailer 102). According to some embodiments, a width of trailer 102 may be substantially similar to a width of cab 104 along the lateral direction. In such cases, first hinge 304 may include a device or devices configured to move, slide, or otherwise shift arm assembly 302 outward along the lateral direction. The device or devices may include a rail and slider, a flap-hinge, a roller, or the like. The hinge construction enables the arm assembly to be located in the plane parallel to the trailer side 108 so that the arm can be moved to place the sensor in the required location, and without contacting the trailer.

First hinge 304 may be attached, connected, fixed, or the like at a first predetermined location on vehicle 100. One or more fasteners (e.g., screws, bolts, rivets, etc.) may be incorporated to fix first hinge to vehicle 100. For example, in the instance that vehicle 100 is an autonomous truck, first hinge 304 may be attached at a cabin (or cab) 104. As shown in FIGS. 5 and 6, first hinge 304 may be positioned at or near a rear of cabin 104 (e.g., proximate trailer 102). Additionally or alternatively, first hinge 304 may be positioned at or near a lateral side of cab 104. According to some embodiments, two or more arm assemblies 302 (e.g., each having a respective dedicated first hinge 304) may be incorporated, such as at either lateral side of cab 104. Thus, a first arm assembly 302 may be positioned at a first lateral side of vehicle 100 while a second arm assembly 302 may be positioned at a second side of vehicle 100. A precise location or placement of first hinge 304 may vary according to specific embodiments, and the disclosure is not limited to the examples provided herein.

Arm assembly 302 may include a beam arm 306. As mentioned above, beam arm 306 may be coupled with first hinge 304. In detail, beam arm 306 may include a first end 308 and a second end 310 opposite first end 308. First end 308 may be operably or movably coupled with first hinge 304 such that a location of second end 310 is positionable with respect to or relative to first hinge 304. According to at least some embodiments, beam arm 306 is a rigid or semi-rigid member extending along a predetermined length. Further, as mentioned above, beam arm 306 may include two or more segments adjustable with respect to each other. For instance, beam arm 306 may be telescopic such that a total length of beam arm 306 (e.g., between first end 308 and second end 310) may be adjusted.

Arm assembly 302 may include a sensor coupler 312. Sensor coupler 312 may be attached to or connected with beam arm 306. For instance, sensor coupler 312 may be provided along a length of beam arm 306. According to at least some embodiments, sensor coupler 312 is provided or positioned at or near second end 310 of beam arm 306. Additionally or alternatively, sensor coupler 312 may be slidably engaged with beam arm 306. For instance, sensor coupler 312 may be configured to slide along the length of beam arm 306 (e.g., between first end 308 and second end 310). Moreover, sensor coupler 312 may be configured to rotate or revolve with respect to beam arm 306. Accordingly, sensor coupler 312 may move in multiple directions with respect to beam arm 306. In some instances, sensor coupler 312 is attached to beam arm via one or more rails, gears, slides, bearings, or the like.

Sensor coupler 312 may be adapted to affix the one or more sensors 202 (e.g., cameras, instruments, or the like) at a second location on vehicle 100. The second location may be different from the first location (e.g., the location of first hinge 304). According to some embodiments, the one or more sensors 202 are attached to a connected trailer (e.g., trailer 102). For instance, the one or more sensors 202 may be fixed at a lateral side panel of trailer 102 (e.g., via beam arm 306). In detail, trailer 102 may be enclosed (e.g., via one or more panels, coverings, or the like) such that the one or more panels define external surfaces to which the one or more sensors 202 may be attached. Additionally or alternatively, trailer 102 may be a flatbed trailer (e.g., with no side panels) or a soft-sided trailer (e.g., with a soft or otherwise malleable cover). Accordingly, sensors 202 may be attached to a side or edge of a frame or bed of trailer 102. As the one or more sensors 202 are attached to trailer 102, certain measurements (e.g., trailer yaw, trailer roll, trailer pose, etc.) may be monitored autonomously via the one or more sensors 202. Thus, as will be explained in further detail below, the one or more sensors 202 may be powered by a battery after disconnecting from arm assembly 302 once attached to vehicle 100.

Sensor coupler 312 may include one or more attachment mechanisms. In detail, sensor coupler 312 may include at least one of a suction cup, a hook, a magnet, a screw, a bolt, a clip, a harness, or the like. By way of the attachment mechanism, sensor coupler 312 may selectively hold, grasp, or grip sensor 202 as it is transported or moved to the second position on vehicle 100. Once at the second location, the attachment mechanism may then secure sensor 202 to vehicle 100 (e.g., to trailer 102). For one example, a suction cup may be attached to sensor 202. Once the suction cup is properly located on vehicle 100, an attached air hose may remove air from a sealed area between the cup and vehicle 100 (e.g., by way of an air pump). It should be understood that any suitable attachment mechanism may be provided at sensor coupler 312 and the disclosure is not limited to the examples provided herein.

Arm assembly 302 may include an actuator 314. According to at least some embodiments, actuator 314 is provided at first hinge 304. For instance, actuator 314 may be provided integrally with first hinge 304. Actuator 314 may be adapted or configured to move or position beam arm 306 (e.g., with respect to vehicle 100). In some instances, actuator 314 is a linear actuator. Actuator 314 may be autonomously controlled. As will be described below, actuator 314 may be initiated or activated in response to a signal to maneuver beam arm 306 to properly position sensor 202 on vehicle 100.

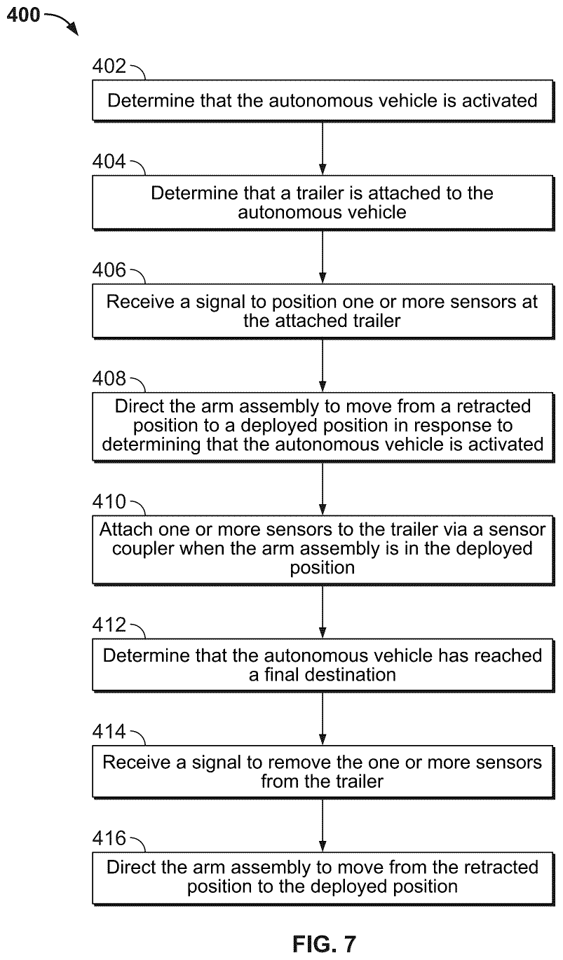

Now that the general descriptions of autonomous vehicle 100 and arm assembly 302 have been explained, a method of operating an autonomous vehicle (e.g., vehicle 100) will be described in detail. Although the discussion below refers to the exemplary method 400 of operating autonomous vehicle 100, one skilled in the art will appreciate that the exemplary method 400 is applicable to any suitable vehicle to which one or more sensors may be attached. In exemplary embodiments, the various method steps as disclosed herein may be performed by controller 240 and/or a separate, dedicated controller. FIG. 7 provides a flow chart illustrating a method of operating a vehicle. Hereinafter, method 400 will be described with specific reference to FIG. 7.

At 402, method 400 may include determining that the autonomous vehicle is activated. In detail, the autonomous vehicle (e.g., autonomous vehicle 100) may be started up, initiated, or otherwise turned on. In some instances, the vehicle is activated remotely, such as according to a remote input. In determining that the autonomous vehicle is activated, method 400 may include confirming that one or more connections (e.g., communications, electronic connections, etc.) are present between two or more devices, terminals, instruments, or the like within the vehicle.

At 404, method 400 may include determining that a trailer is attached to the autonomous vehicle. For instance, one or more sensors may be provided or included on the vehicle to sense, confirm, or otherwise determine that an additional or supplemental body is attached to the autonomous vehicle. In the instance of an autonomous truck, for example, a trailer (e.g., trailer 102) may be selectively coupled to the autonomous tractor (e.g., cab 104).

At step 406, method 400 may include receiving a signal to position one or more sensors on the attached trailer. In detail, upon determining that that the trailer is attached, a secondary signal or input may be received (e.g., by the autonomous vehicle) to temporarily position one or more sensors on the attached trailer (e.g., sensor or sensors 202). In some instances, the signal to position the one or more sensors is based on one or more of a plurality of factors, such as cargo load type, distance to destination, weather forecasts or patterns, selected routes, or the like.

After receiving the signal to position the one or more sensors on the attached trailer, at 408, method 400 may include directing the arm assembly to move from a retracted position to a deployed position. Thus, after the autonomous vehicle is activated, the arm assembly (e.g., arm assembly 302) may initiate a placement operation. As mentioned above, the arm assembly may include a beam arm, a sensor coupler, and an actuator configured to maneuver the beam arm to a selected position. Accordingly, the actuator may be activated to move (e.g., via the beam arm) the sensor coupler to a predetermined position (e.g., the deployed position).

As mentioned above, the deployed position of the arm assembly may be associated with a second position on the vehicle (or an attached trailer). The second position may be determined according to a type, style, size, shape, or material of the vehicle or trailer. In some instances, the second position is one of a plurality of pre-stored positions within a memory of the vehicle. Additionally or alternatively, the second position may be determined in real time via a camera or image capture device on the arm assembly.

At 410, method 400 may include attaching the one or more sensors to the trailer via the sensor coupler. In detail, once the arm assembly is in the deployed position such that the sensor coupler is at the second position, the sensor coupler may be initiated or activated to attach, affix, or otherwise place the one or more sensors on the trailer. As mentioned above, the sensor coupler may include an attaching mechanism, such as a suction cup, a magnet, a hook, a screw, or the like. Thus, method 400 may confirm that the one or more sensors is or are in contact with the trailer before performing the attachment operation.

According to some embodiments, after attaching the one or more sensors to the trailer, the arm assembly may be maneuvered or returned to the retracted position. For instance, the arm assembly may be stowed before the vehicle begins traveling. Thus, the one or more sensors may be released from the arm assembly (e.g., via a releasing mechanism) before the arm assembly is moved to the retracted position. As mentioned above, the one or more sensors may be powered by an onboard battery. Each of the one or more sensors may store collected data during the trip. In additional or alternative embodiments, each of the one or more sensors may transmit collected data in real time (e.g., to a controller onboard the vehicle).

At 412, method 400 may include determining that the autonomous vehicle has reached a final destination. In detail, the vehicle may have a pre-planned route or trip including the final destination. Method 400 may thus receive a signal that the route has completed. In some instances, one or more additional sensors may be utilized to determine the completion of the trip or route, such as a global positioning system (GPS, a live feed camera, a proximity sensor, or the like.

At 414, method 400 may include receiving a signal to remove the one or more sensors from the trailer. For instance, upon reaching the final destination, method 400 may include instructing the arm assembly to retrieve the one or more attached sensors. Similar to 406, the signal may be generated at the vehicle (e.g., via an onboard controller).

At 416, method 400 may include directing the arm assembly to move from the retracted position to the deployed position. For instance, after receiving the signal to remove the one or more sensors, the arm assembly may be maneuvered (e.g., via the actuator or first hinge) to retrieve the one or more placed sensors. As such, the sensor coupler may be positioned at the one or more sensors once the arm assembly is appropriately maneuvered.

The sensor coupler may then be attached to the at least one sensor (e.g., when the beam arm is in the deployed position). Additionally or alternatively, the one or more sensors may be removed or detached from the trailer. At such time, the arm assembly may be returned to the retracted position together with the one or more sensors.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A sensor attachment system for an autonomous vehicle, the autonomous vehicle comprising a tractor portion and a trailer portion selectively coupled to the tractor, the sensor attachment system comprising:
an arm assembly attached to the tractor, the arm assembly moveable between a retracted position and a deployed position, the arm assembly comprising
a first joint attached to the tractor at a first location;
a beam arm coupled with the first joint, the beam arm being moveable relative to the first hinge; and
a sensor coupler provided along a length of the beam arm, the sensor coupler being adapted to affix one or more sensors at a second location on the trailer.

2. The sensor attachment system of claim 1, wherein the first joint comprises an omni-directional hinge capable of maneuvering the beam arm in at least 6 degrees of freedom.

3. The sensor attachment system of claim 1, wherein the first joint comprises:
an actuator configured to move the beam arm between the retracted position and the deployed position.

4. The sensor attachment system of claim 3, wherein the actuator is a linear actuator.

5. The sensor attachment system of claim 1, wherein the tractor portion comprises a cab, and wherein the arm assembly is attached at a rear of the cab.

6. The sensor attachment system of claim 1, wherein the sensor coupler is slidably engaged with the beam arm.

7. The sensor attachment system of claim 1, wherein the arm assembly is a first arm assembly positioned at a first lateral side of the tractor, and wherein the sensor attachment system further comprises:
a second arm assembly positioned at a second lateral side of the tractor opposite the first arm assembly.

8. The sensor attachment system of claim 1, wherein the at least one sensor comprises a camera or an inertial measurement unit (IMU).

9. The sensor attachment system of claim 1, wherein the sensor coupler is provided at a distal end of the beam arm opposite the first joint.

10. The sensor attachment system of claim 9, wherein the sensor coupler comprises at least one of a suction cup, a hook, a magnet, or a screw.

11. The sensor attachment system of claim 1, wherein the at least one sensor is fixed to a lateral side panel of the trailer via the beam arm.

12. A method of operating an autonomous vehicle, the autonomous vehicle comprising, a tractor portion, a trailer portion selectively coupled to the tractor portion, and an arm assembly, the method comprising:
determining that the tractor portion of the autonomous vehicle is activated;
directing the arm assembly to move from a retracted position to a deployed position in response to determining that the tractor portion of the autonomous vehicle is activated; and
attaching one or more sensors to the trailer via a sensor coupler when the arm assembly is in the deployed position.

13. The method of claim 12, further comprising:
determining that the trailer is connected to the tractor after determining that the autonomous vehicle is activated; and
receiving a signal to position the one or more sensors at the attached trailer after determining that the trailer is connected to the tractor.

14. The method of claim 12, wherein the arm assembly comprises:
a first hinge attached at the tractor;
a beam arm movably coupled with the first hinge; and
a sensor coupler provided at a distal end of the beam arm opposite the first hinge.

15. The method of claim 14, further comprising:
determining that the one or more sensors are attached to the trailer; and
moving, via the arm assembly, the beam arm from the deployed position to the retracted position after determining that the one or more sensors are attached to the trailer.

16. The method of claim 14, further comprising:
determining that the autonomous truck has reached a final destination;
moving, via the first hinge, the beam arm from the retracted position to the deployed position after determining that the autonomous truck has reached the final destination;
attaching the beam arm to the at least one sensor when the beam arm is in the deployed position; and
removing the at least one sensor from the trailer after attaching the beam arm to the at least one sensor.

17. The method of claim 14, wherein the arm assembly further comprises:
an attachment mechanism provided at the distal end of the beam arm, the attachment mechanism configured to secure the at least one sensor to the trailer.

18. The method of claim 17, wherein the attachment mechanism comprises at least one of a suction cup, a hook, a magnet, or a screw.

19. The method of claim 14, wherein the autonomous vehicle is an autonomous truck comprising a tractor portion and a trailer portion.

20. The method of claim 19, wherein the tractor portion comprises a cab, and wherein the arm assembly is attached at a rear of the cab.
